(19) United States
(12) Patent Application Publication
(10) Pub. No.: US 2018/0085673 A1
(43) Pub. Date: Mar. 29, 2018

(54) Vest and Motion Sensitive Wand for Interactive Game Play

(71) Applicant: Ole Birkedal, St. Louis, MO (US)

(72) Inventor: Ole Birkedal, St. Louis, MO (US)

(21) Appl. No.: 15/693,320

(22) Filed: Aug. 31, 2017

Related U.S. Application Data
(60) Provisional application No. 62/381,700, filed on Aug. 31, 2016.

(51) Int. Cl. A63F 13/822; A63F 13/92; A63F 13/211; A41D 1/00; A63F 13/212; A63F 13/285; A63F 13/847; A63F 13/235; A63F 13/25; A63F 13/79; A63F 13/46; A63F 13/428; A63F 13/327; A63F 13/35

(52) U.S. Cl. CPC A63F 13/822; A63F 2300/405; A63F 13/211; A41D 1/002; A63F 13/212; A63F 13/285; A63F 13/847; A63F 13/235; A63F 13/25; A63F 13/79; A63F 13/46; A63F 13/428; A63F 13/327; A63F 13/35; A63F 2300/8094; A63F 13/92

(57) ABSTRACT

An interactive magical themed game played by one or more players. Each player is equipped with a motion sensitive wand, capable of casting infrared spells, a vest, capable of receiving infrared spells, and a smartphone, capable of displaying scores and creating user profiles. Vest, wand, and smartphone are connected and equipped with Bluetooth technology. All Bluetooth connections are facilitated by a smartphone app. The app also stores and accesses user information in an online server. The game enables players to win points by casting spells at opponents and defending themselves from the spells of opposing players.

### BACKGROUND OF THE INVENTION

### Field of the Invention

The present invention generally relates to a game, which may be played by adults or children. In particular this invention relates to play systems and interactive toys, specifically vests and motion sensitive wands, which may be able to send and receive Bluetooth and Infrared signals, and connect with an app and an online server.

### Prior Art

Many people all over the world dream of living their lives as witches or wizards. They are enamored with the idea of interacting with people in a magical way. They also have a strong desire for magic to be incorporated in a game, which is fun and exciting. Unfortunately, this dream and these desires remain unfulfilled. Moreover, the continued release of magical themed movies and books has exacerbated the need for a magical themed game.

People want the ability to play a game at any location. They also want to play a game even if they are walking or travelling somewhere. The prior art, however, lacks the ability to be played at any given location. Much of the prior art is best played indoors and at specific locations or environments and is not designed to be played while the player is mobile.

The prior art allows players to interact with each other, but only in a limited and indirect way. People want to play games and face their opponents directly, without a television screen, or board game, getting in the way. There is a great need for a game, which allows people to interact with each other.

Some of the prior art is large and bulky. This creates a problem if people want to play a game at a different location or on the move. They have to pick up the game and carry it to the destination. Some games need to be packed beforehand and some need to be assembled on site. These are all things that create a barrier to having fun with an interactive game. People do not want to carry a game that is large and bulky. Instead people want to use their smartphone, which they already carry with them, as part of an interactive game.

Moreover, the game data of some of the prior art can only be accessed at specific times and must be projected on a television screen or handed out on paper. Sometimes the players themselves must calculate the number of spaces to move or the amount of points they earn, which can lead to error. Therefore, the prior art lacks the ability to share accurate live game data to all players.

In addition, the prior art doesn't utilize smartphones to communicate with an online server to store and process information of all actions in the game. For example, the lack of an online server limits the ability of a player to create a personal profile online and easily change teams. Without an online server, the possibility of easily sorting players into teams, livestreaming team scores, tracking each player's achievements, ranking players, and storing the player's information is extremely impractical. The prior art lacks this ability to track each infrared and Bluetooth transmission and linking that information to each player's profile. Since the prior art lacks the possibility of registering and storing each user achievement and linking that to the player's profile, it falls short in its ability to foster the experience of being a witch or a wizard. It is lacking because this technology is most often limited to individual games, while there is a need to store all the achievements of the player to his or her user identity that goes beyond each individual game to benefit the player over time, over multiple games, and thus add to the experience of being a witch or a wizard. In short, the prior art lacks the ability to tie each user achievement to his or her online profile both within a game with one set of people and over multiple games with different sets of people.

Finally, the prior art utilizes a variety of wireless signals, yet it does not utilize Bluetooth technology to connect the wand to a smartphone for an enhanced play experience.

### Summary of Invention and Advantages

Although the prior art has failed in certain areas, as mentioned above, the present invention has succeeded. By using magical themed toys, which can interact with other players, this invention provides a unique gaming experience. Furthermore, game players may feel a real or imagined sense of experiencing or possessing magic. These and other objects of the invention will be apparent to those skilled in the art from the description that follows.

In this game, each player is equipped with a motion sensitive wand, a vest, smartphone, and app. There is no limit to the number of people who may play this game. There is also no limit to where the game may be played, so long as the smartphone of the player has access to the internet. The game is primarily designed to be played by one or more players, who may be part of teams. The magical themed toys, e.g. vest and motion sensitive wand, are connected via Bluetooth to the smartphone of the player. In summary, the smartphone of each player is connected to one wand and one vest. The smartphone is also connected to the game server through the internet signal of the smartphone. Our game utilizes a smartphone app, which facilitates all these connections.

One of the goals of the game is to get the highest score, which is the sum of all the points earned. Points are typically earned by casting spells at opponents, although there are other ways to earn points. Spells are predetermined gestures, which can be made by any player with a motion sensitive wand. The gesture of a spell may conclude with the tip of the wand pointed at the opponent's vest. When a player casts a spell, the wand sends an infrared signal in the direction, in which the wand is pointing. Each infrared signal follows a custom infrared protocol that, among other things, contains information about the player who cast the spell. For example, when Player 1 successfully casts a spell at the vest of Player 2, the vest of Player 2 reads the player and type of spell and relays that information to the smartphone of Player 2, which passes information to the game server. Through two-way-communication between the smartphone of Player 2 and Player 1 via the online server, Player 1 is awarded points and Player 2 has points subtracted. This information and all other game data may be accessed by any player in the game via the app on the smartphone, which is connected to the game server. The points, which each player earned during the game, are added to the player's total score. Players are ranked based on the points they earn.

This invention satisfies the need for a magical themed game, which can be played anywhere. This invention encourages players to interact and communicate with each other as they create strategies to win. This invention is small, light, and extremely portable. This invention keeps players up to date with accurate scores and other game related information that are stored with the user's profile.

### BRIEF DESCRIPTION OF THE DRAWINGS

Having described some of the features and advantages of the embodiments, reference will now be made to the drawings. The drawings are not necessarily drawn to scale.

FIG. 1 illustrates a perspective view of the inflexible portion of the vest from the front. This illustration also shows a partial view of the straps.

FIG. 2 illustrates a perspective view of the inflexible portion of the vest from the back. This illustration does not show the straps attached.

FIG. 3 illustrates a perspective view of the inflexible portion of the vest from the bottom. This illustration does not show the straps attached.

FIG. 4 illustrates a sectional view of the inflexible portion of the vest from the front side without the straps.

FIG. 5 illustrates a perspective view from the front of a player, who is wearing the vest and the straps.

FIG. 6 illustrates a perspective view from the rear of a player, who is wearing the vest and the straps.

FIG. 7 illustrates a perspective view from the side of a player, who is wearing the vest and the straps.

FIG. 8 illustrates a perspective view of the wand from the top.

FIG. 9 illustrates a sectional view of the wand from the top and also a schematic of the circuit board located inside the wand

FIG. 10 illustrates a flow chart of how the game is played.

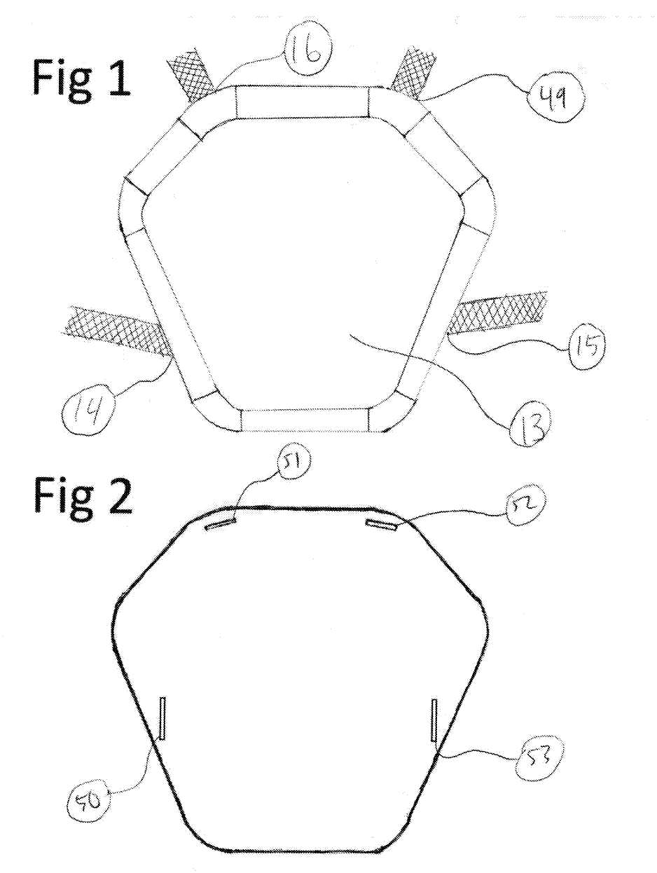

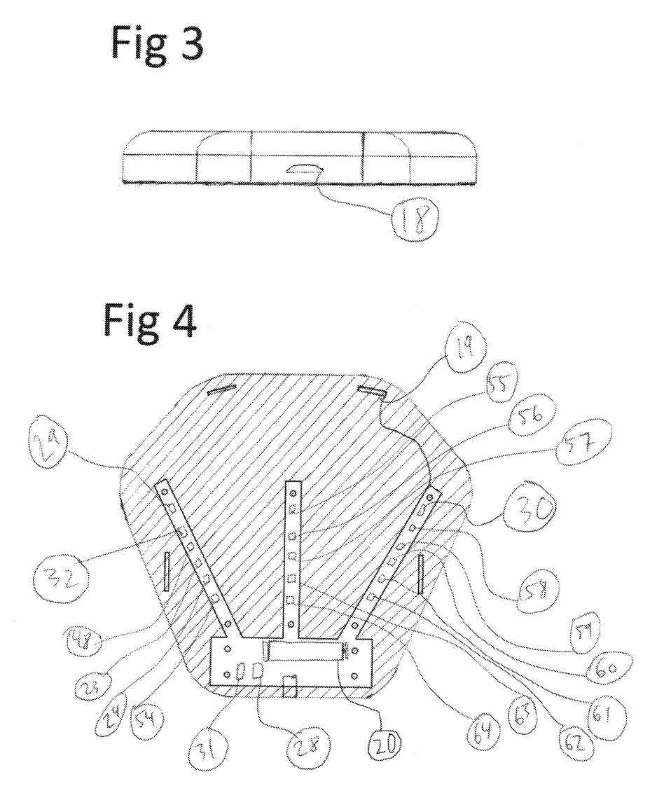

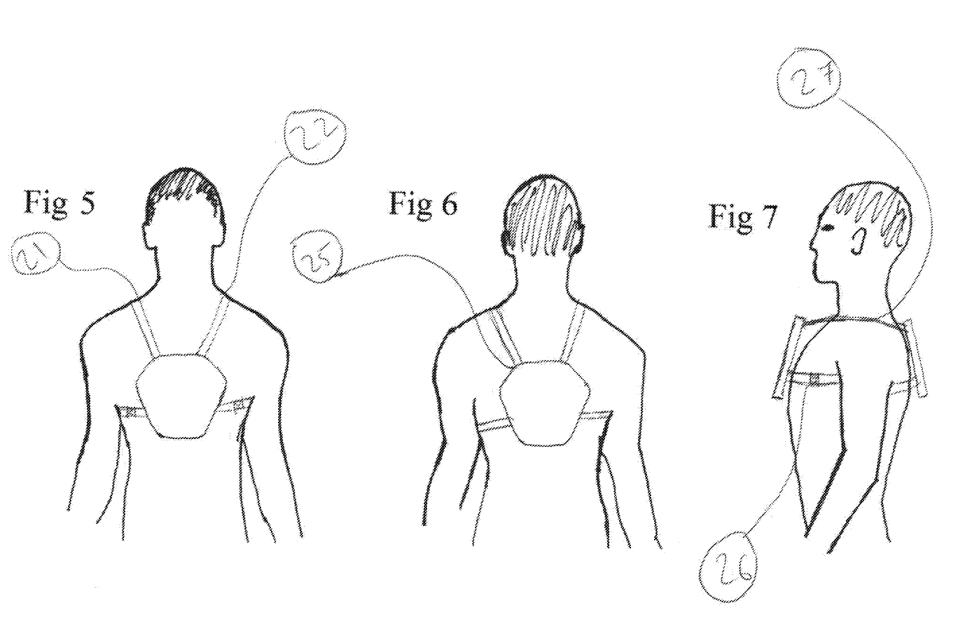

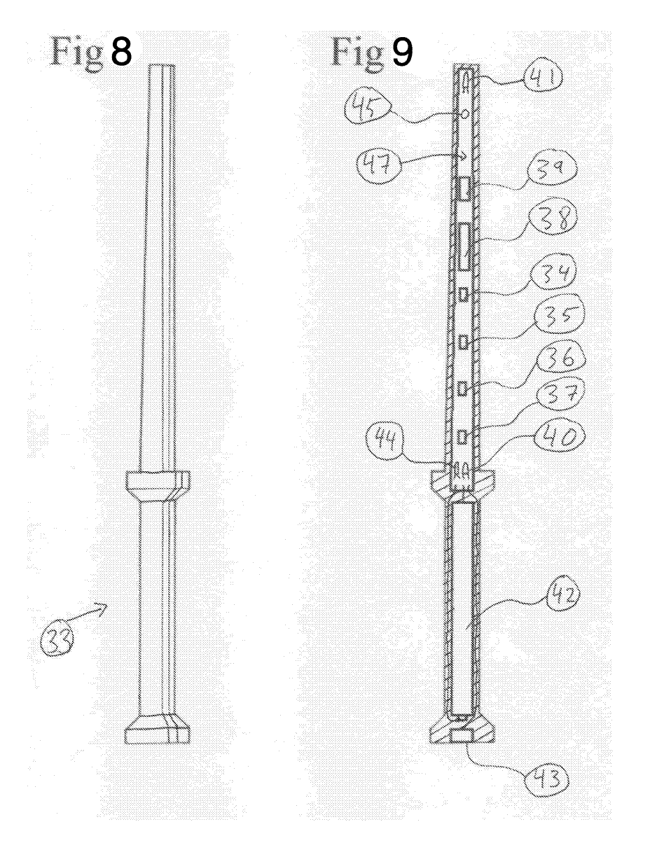

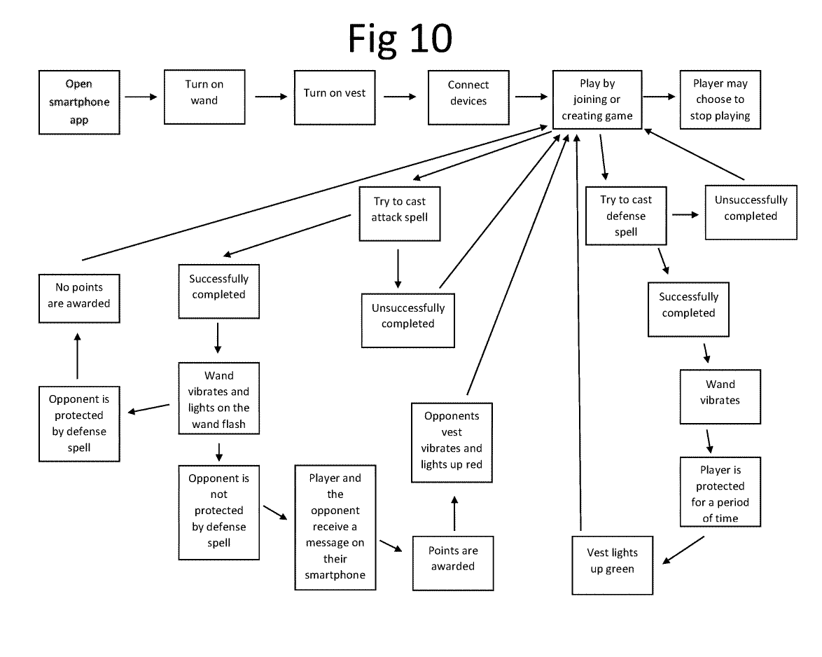

### DETAILED DESCRIPTION OF THE PREFERRED EMBODIMENT

The terminology used herein is to describe the preferred embodiments only, and is not intended to limit the present invention. Indeed, these inventions may be embodied in many different forms.

Before game play may begin, each player opens the smartphone app and logs into the game. The smartphone app directs the player to turn on the wand and the vest. The wand and vest may be turned on in a variety of ways, either by Bluetooth, Infrared, a motion registered by the accelerometer, or by a switch. The app then scans for Bluetooth devices and then connects the wand and the vest to the smartphone. Once the wand and the vest are connected to the smartphone, the smartphone app is ready to transmit data and relay any information to an online server.

A player may create or join a single or multi-player game. All games may utilize location sensors, motion sensors, or other sensors. The wand should be held with one hand at the handle 33 and the straps 27 of the vest should be worn around the neck 21 22. The preferred embodiment of the wand and vest may be made out of a variety of plastics. The embodiment of the vest and wand, however, is not limited to plastics and may be made of wood, metal, and other materials. The player should make sure the straps 14 15 16 are attached to the inflexible portion of the vest. The player should also fasten the clip 26 on the side of the vest. All of the straps connect to the rear vest plate 25 in the back. The vest on the back is identical to the front. The vest sits comfortably on the chest of the player, because the vest can be tightened to fit the shape of the player's body.

The main goal of the game is to earn points by making gestures with the motion sensitive wand. Hereafter making gestures with the wand may be referred to as casting spells. The player may choose between casting an attack spell, to win points, and a defense spell, to stop an opposing player from winning points. The player may also use the wand to interact with the same player's smartphone, other players, and other magical themed toys. Some attack spells are designed to hit the infrared light receiver 40 in the wand. Each spell has a unique gesture, which the player must learn in order to cast the spell. Defense spells may be used to protect the same player. Attack spells may be used to win points for the same player.

A spell is cast using the technology inside the preferred embodiment of the wand. The motion sensor 45 is a combination of an accelerometer and gyroscope. This allows the microcontroller 38 to analyze the rotation and acceleration of any gesture. An alternative embodiment of the wand may also include a magnetometer on the circuit board, which would allow the microcontroller to analyze magnetic forces, such as magnetic north. The motion sensor is attached to the circuit board 47 inside the wand and detects every motion and sends the information to the microcontroller. The microcontroller analyzes the accelerations and the rotations and determines if they meet the predefined thresholds needed for a particular spell. The process of making gestures in order to meet the unique thresholds for a spell is called building the spell. Once the player has met the first threshold of a spell the LED light 41 closest to the handle of the wand lights up. The player may try to meet the thresholds of a spell as many times as necessary. As the player builds the spell by meeting each additional threshold of the spell, additional LED lights 34 35 36 37 on the circuit board of the wand light up. Once the player has built the spell, the same player may execute the spell, by making a rapid forward motion with the wand. When the spell is executed the vibrator 39 makes a short vibration, giving the player feedback. The player may execute the spell as often as desired. The thresholds for each spell are stored in the memory of the microcontroller. The microcontroller may have Bluetooth capability. If the microcontroller does not have Bluetooth capability the circuit board will have a separate Bluetooth chip. Some spells have fewer and simpler thresholds than other spells. This allows players a better chance to build and execute a spell. Some spells are difficult to build and execute. Therefore, the varying difficulty of the spells allows players with beginner skill the ability to play and have fun with players who have advanced skill. Randomly waving the wand may not cast a spell. The goal of the player is to build a spell and then execute the spell. If the gestures of the player meet all the thresholds of a spell, the microcontroller will execute the command assigned to that particular spell. Defense spells protect the player, who is casting the defense spell. Attack spells win points for the player, who is casting the attack spell.

When an attack spell is successfully built and executed, the microcontroller inside the wand sends signals through the infrared diode of the wand 44. The infrared diode, then, emits an infrared signal in the direction in which the wand is pointing. Each infrared signal uses a proprietary communication protocol to send information. Typically, players aim at the inflexible portion 13 of an opposing player's vest or an opposing player's wand. The goal of the player, however, is to point the wand at an opposing player's infrared light receivers 29 30 on the vest and infrared light receiver 40 on the wand. The infrared sensors and led lights on the vest of the players back side are connected to the circuit board of the vest on the front side by wires 19. When the infrared receivers, which are soldered on the circuit board inside the inflexible portion of the vest, detect an infrared signal, the signal is immediately sent to the microcontroller 28 inside the vest of the opposing player. The microcontroller reads which player emitted the signal and to what team he or she belonged. The microcontroller matches the spell pattern up with any predefined spell patterns in memory. The microcontroller inside the vest sends a signal via Bluetooth to the smartphone, to which it is connected. The smartphone sends the relevant information to the game server, which stores that information together with the player's profile and awards points to the player, who sent the infrared signal. In the effort to create a fulfilling mobile game, LED lights 48 32 23 24 54 64 63 57 56 55 58 59 60 61 62 and a vibration motor 31 are used inside the vest. The lights and vibrators are used to give players feedback of what is happening in the game. The LED lights may light up in different colors and the vibrators may vibrate in different intensities.

When a player successfully casts a defense spell, the microcontroller inside the wand sends a Bluetooth signal to the phone of the same player, which ensures that the same player will be protected for a certain period of time. When a player is protected with a defense spell, the next opposing player who casts an attack spell may not be rewarded points. Game play may end when the player quits the game and may resume at any time. Players may charge the rechargeable battery 42 of the wand and the rechargeable battery 20 of the vest. This is done by attaching a USB cable to the connector 43 in the wand and the connector 18 in the vest.

The game server contains all the scores of the players and may post the leaders of the game on the game's website or on the player's smartphone. In this way, skilled players are celebrated. Scores and rankings of all players may be found on the player's smartphone app and the game's website.

The smartphone app is an integral part to the invention, because it facilitates the connections to the wand, vest, and game server. The app also gives feedback to the player in the form of sounds, vibrations, and animations on the smartphone. The smartphone app may be used on a variety of smartphones.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

What is claimed is:

1. An interactive game comprising:
a motion sensitive wand capable of transmitting Bluetooth and Infrared signals and measuring, storing, and analyzing accelerometer, magnetometer, and gyroscope readings; and
a vest capable of receiving infrared signals and transmitting Bluetooth signals as described herein; and
an infrared protocol that communicates player identity in each infrared transmission, along with any other pertinent information, such as team name, spell type, etc.; and
an app that connects to and communicates with the vest and wand via Bluetooth and relays information to an online game server; and
an online server that stores information from the game and links that information to the profile of each player.

2. The game of claim 1 wherein the game may be played anywhere an online connection to the server may be facilitated.

3. The game of claim 1 claim wherein the game may be played by any number of people, whose smartphones are connected to the game servers.

4. The wand of claim 1, wherein there is a microcontroller and Bluetooth technology, and one or more motion sensors, such as accelerometer, gyroscope, and magnetometer, and one or more LEDs, infrared sensors, infrared emitters and vibration motors.

5. The wand of claim 1, wherein the microcontroller can read multiple Degrees of Freedom from the motion sensors and process those readings either directly or through any number of filtering algorithms such as Euler Angles, Kalman Filter, or Quaternions to gain an accurate reading of the movements of the wand.

6. The wand of claim 1, wherein the microcontroller can analyze the movements to match a predefined set of spells, and when there is a match, emit a predefined infrared pattern.

7. The wand and vest of claim 1, wherein the wand and vest receive infrared signals and the microcontroller of each processes which team and player sent the signals.

8. The wand and vest of claim 1, wherein the microcontroller of each searches its memory for a pattern that matches a received infrared signal, and when there is a match, rewards the player who sent the infrared signal and sends any pertinent information to the app over Bluetooth.

9. The wand and vest of claim 1, wherein the wand and vest can light up in various ways and colors, vibrate, and give other sensory feedback.

10. The vest of claim 1, wherein there is a microcontroller, Bluetooth technology, LEDs, infrared sensors, and vibration motors.

11. The infrared protocol of claim 1, wherein the unique player number and the team number are included in each infrared transmission.

12. The infrared protocol of claim 1, wherein each infrared transmission can be traced throughout the whole system and be associated with the player who sent the infrared signal and the player who received it.

13. The infrared protocol of claim 1, wherein the player may not be affected by the same player's spells, because the infrared protocol may filter out these spells.

14. The app of claim 1, wherein each player in the game may be assigned a team that may be shared with other players, and assigned a unique player identity.

15. The app of claim 1, wherein the team and unique player identity are sent to the game server, wand, and vest to be stored there and be used in the infrared protocol.

16. The app in claim 1 wherein the game data, pertinent to each player, may be accessed by that same player at any time via a smartphone.

17. The app of claim 1, wherein players can be sorted into teams in several ways, such as by using Near Field Communication to group players into their teams by bringing their phones in close proximity or by using a one-time passkey.

18. The app of claim 1, wherein any information from the wand and vest can be displayed along with any pertinent information from the server, such as team scores followed by sounds, vibrations, animations, etc.

19. The online server of claim 1, wherein every user profile may be stored.

20. The online server of claim 1, wherein the information from the wand, vest, and phone of each player is stored together with that player's user profile along with any possible past actions and achievements registered in previous games.
